(19) United States
(12) Patent Application Publication
(10) Pub. No.: US 2022/0072693 A1
(43) Pub. Date: Mar. 10, 2022

(54) Multi-Function Touch-Free Tool

(71) Applicant: Strike Industries, Inc., Santa Ana, CA (US)

(72) Inventors: Shanyao Lee, Santa Ana, CA (US); Shih-Ting Hung, Taoyuan City (TW)

(21) Appl. No.: 17/013,001

(22) Filed: Sep. 4, 2020

(51) Int. Cl. B25F 1/00; B67B 7/16

(52) U.S. Cl. CPC B25F 1/00; A47G 25/28; B67B 7/16

(57) ABSTRACT

A handheld tool includes a single piece having various sections including a first open loop section, a second open loop section and a connection section connecting the first open loop section and the second open loop section. The first open loop section has a first opening toward a first side of the handheld tool. The second open loop section has a second opening toward a second side of the handheld tool opposite the first side thereof.

### TECHNICAL FIELD

The present disclosure is generally related to hand tools and, more particularly, to a touch-free tool with multiple functions.

### BACKGROUND

Unless otherwise indicated herein, approaches described in this section are not prior art to the claims listed below and are not admitted as prior art by inclusion in this section.

There may be situations in which it is not desirable for a person to make direct contact with other people and/or objects in the surrounding. For example, as the world is currently suffering the pandemic of coronavirus, it may be dangerous or otherwise risky to one's health to come in contact with surfaces and objects which may be contaminated by coronavirus. One way to avoid touching surfaces and objects directly is the use of a brass touch tool or a keychain touch tool. However, such tools currently available on the market tend to be designed for this single purpose.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose designs of a touch-free tool with multiple functions. With the touch-free tool, a user would be able to avoid physical contact, or touch, with objects that the user would otherwise need to touch without the tool. Moreover, the touch-free tool offers versatility in functionality in that it may be used to perform various functions.

In one aspect, a device may include a handheld tool including a single piece having various sections, namely: a first open loop section, a second open loop section, and a connection section connecting the first open loop section and the second open loop section. The first open loop section may be configured with a first opening toward a first side of the handheld tool. The second open loop section may be configured with a second opening toward a second side of the handheld tool opposite the first side thereof.

In another aspect, a device may include a handheld tool including a single piece having various sections, namely: a first open loop section, a second open loop section, and a connection section connecting the first open loop section and the second open loop section. The first open loop section may be configured with a first opening toward a first side of the handheld tool. The second open loop section may be configured with a second opening toward a second side of the handheld tool opposite the first side thereof. A first dimension of the first opening, measured from a first distal end of the first open loop section to the connection section, may be less than a second dimension of the second opening, measured from a second distal end of the second open loop section to the connection section.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, explain the principles of the disclosure. It is appreciable that the drawings are not necessarily in scale as some components may be shown to be out of proportion than the size in actual implementation to clearly illustrate the concept of the present disclosure.

FIG. 1 is a diagram of a device in accordance with an implementation of the present disclosure.

FIG. 2 is a diagram of an example scenario in accordance with an implementation of the present disclosure.

FIG. 3 is a diagram of an example scenario in accordance with an implementation of the present disclosure.

FIG. 4 is a diagram of an example scenario in accordance with an implementation of the present disclosure.

FIG. 5 is a diagram of an example scenario in accordance with an implementation of the present disclosure.

FIG. 6 is a diagram of an example scenario in accordance with an implementation of the present disclosure.

FIG. 7 is a diagram of an example scenario in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

The position terms used in the present disclosure, such as “front”, “forward”, “rear”, “back”, “top”, “bottom”, “left”, “right”, “head”, “tail” or the like assume a firearm in the normal firing position, with the firearm being in a position in which the longitudinal axis of the barrel of the firearm runs generally horizontally and the direction of firing points “forward” away from the operator or user of the firearm. The same convention applies for the direction statements used herein.

As used herein, the terms “proximal” and “proximally” may denote “forward” and “forwardly” with respect to the firearm, and the terms “distal” and “distally” may denote “rearward” and “rearwardly” with respect to the firearm. As used herein, the verb “to comprise” in this description, claims, and other conjugations are used in its non-limiting sense to mean those items following the word are included, but items not specifically mentioned are not excluded. As used herein, the word “forward” means moving in the direction that the projectile moves during firing a firearm. As used herein, the word “proximal” means closer to the reference point, in this case, the shooter. As used herein, the word “distal” means farther to the reference point, in this case, the shooter. Reference to an element by the indefinite article “a” or “an” does not exclude the possibility that more than one of the elements are present, unless the context clearly requires that there is one and only one of the elements. The indefinite article “a” or “an” thus usually means “at least one.” Additionally, the words “a” and “an” when used in the present document in concert with the words “comprising” or “containing” denote “one or more.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure. The recitation of numerical ranges by endpoints includes all numbers within that range (e.g. 1 to 5 includes 1, 1.5, 2, 2.75, 3, 3.80, 4, and 5). All dimensions given herein are by way of examples to better illustrate the present disclosure embodiments and shall not be construed to limit the dimensions of the present disclosure embodiments to the given numeric values.

### Overview

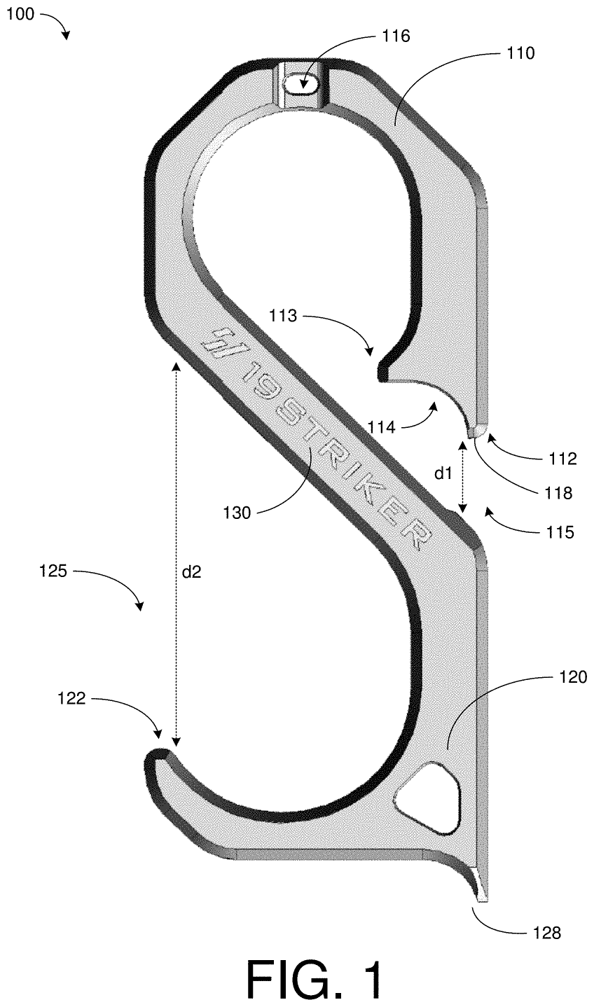

FIG. 1 illustrates a device in accordance with an implementation of the present disclosure. Referring to FIG. 1, the device may include a handheld tool 100 including a single piece having various sections, namely: a first open loop section 110, a second open loop section 120, and a connection section 130 connecting first open loop section 110 and second open loop section 120. First open loop section 110 may be configured with a first opening 115 toward a first side (e.g., right side as shown in FIG. 1) of handheld tool 100. Second open loop section 120 may be configured with a second opening 125 toward a second side (e.g., left side as shown in FIG. 1) of handheld tool 100 opposite the first side thereof. A first dimension (d1) of first opening 115, measured from a first distal end 112 of first open loop section 110 to connection section 130, may be less than a second dimension (d2) of second opening 125, measured from a second distal end 122 of second open loop section 120 to connection section 130. Accordingly, handheld tool 100 may be generally shaped like a letter S, an inverted letter S, a number 2, an inverted number 2, a number 5 or an inverted number 5.

Under a first proposed design, first distal end 112 of first open loop section 110 may include a curved surface 114 with a concave (e.g., curving inwardly) profile and generally facing second open loop section 120. Moreover, the second distal end 112 may have a first pointed tip 118 on a first side of curved surface 114 as well as a protruding tip 113 on a second side of curved surface 114 and pointing toward connection section 130. This design, with the inwardly protruding tip 113, may help prevent handheld tool 100 from slipping off from a loop or hook when disposed thereon. Under the first proposed design, a gap between first pointed tip 118 of first distal end 112 of first open loop section 110 and connection section 130 may be configured such that handheld tool 100 may function as a bottle opener with a cap of a bottle removable from the bottle by first pointed tip 118 of distal end 112 of first open loop section 110 together with connection section 130.

Under a second proposed design, a second pointed tip 128 may protrude outwardly from a midportion of second open loop section 120. Under the second proposed design, second pointed tip 128 may be generally shaped like a flat tip of a screwdriver such that handheld tool 100 may function as a flathead screwdriver.

Under a third proposed design, a midportion of first open loop section 110 may be configured with a through hole 116. Under the third proposed design, when first open loop section 110 or through hole 116 is used to hang handheld tool 100 onto a fixture, second open loop section 120 may function as a hook of a coat hanger or a bag hanger.

In some implementations, handheld tool 100 may be made of a metallic material such as, for example and without limitation, brass, aluminum, steel, another metal, or an alloy. In some implementations, handheld tool 100 may be made of a non-metallic material such as, for example and without limitation, ceramic, silicone or polymers.

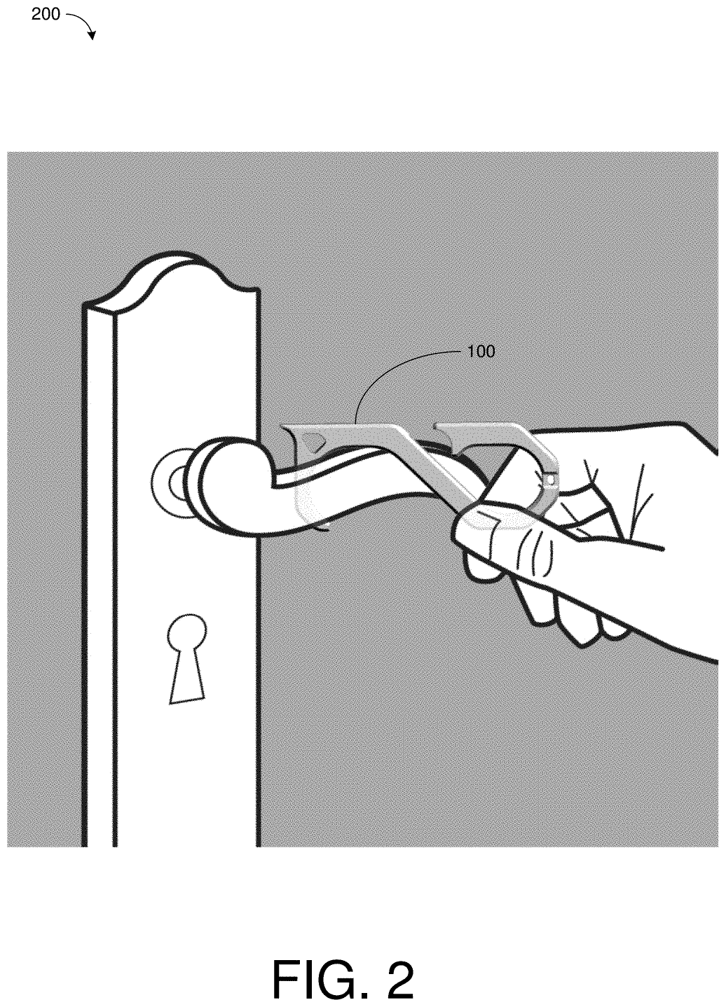

FIG. 2 illustrates an example scenario 200 in accordance with an implementation of the present disclosure. In scenario 200, handheld tool 100 may be used by a user as a door opener to open a door. In the example shown in FIG. 2, second opening 125 of second open loop section 120 may be designed to be sufficiently wide for second open loop section 120 to hook onto a handle of the door such that the user, who is holding first open loop section 110 of handheld tool 100 in hand, may press down on handheld tool 100 to turn the handle to open the door.

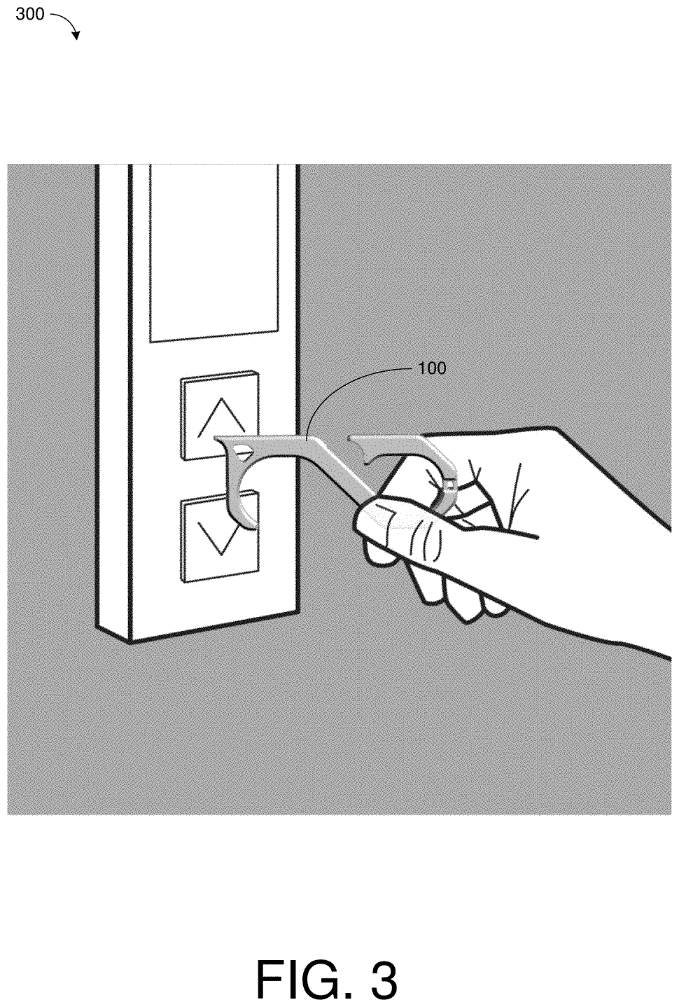

FIG. 3 illustrates an example scenario 300 in accordance with an implementation of the present disclosure. In scenario 300, handheld tool 100 may be used by a user as a button pusher to push a button. In the example shown in FIG. 3, when a user holds first open loop section 110 of handheld tool 100 in hand, second pointed tip 128 may point forward and, thus, may function as a finger of the user. Accordingly, the user may push a button (e.g., a button associated with an elevator) with second pointed tip 128 without having to touch the button himself/herself.

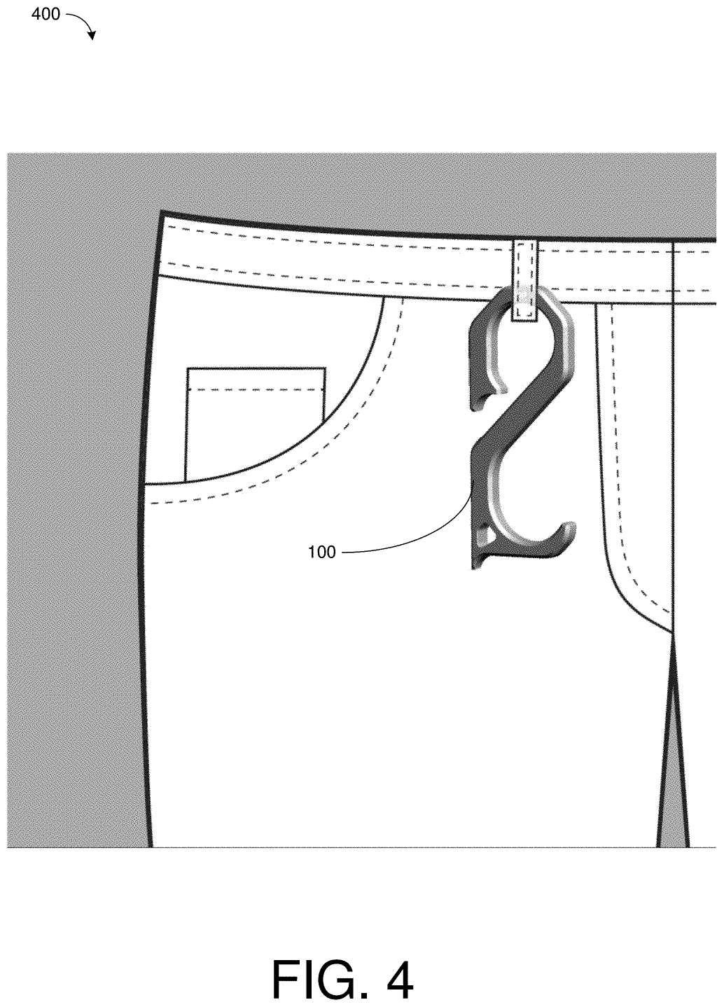

FIG. 4 illustrates an example scenario 400 in accordance with an implementation of the present disclosure. In scenario 400, handheld tool 100 may be conveniently carried by a user, not in a pocket of the user but by hooking onto a portion of the user's apparel/clothing (e.g., a belt loop, a belt or a pocket opening of a pocket). In the example shown in FIG. 4, the user may hook first open loop section 110 of handheld tool 100 onto a belt loop to carry handheld tool 100. This allows handheld tool 100 to be easily and conveniently accessible by the user without the need of reaching into a pocket or a bag to obtain handheld tool 100. Advantageously, there is no additional coupling device required to couple or otherwise attach handheld tool 100 onto the user's apparel or carried bag. In contrast, most brass touch tools on the market usually have a closed-loop design without an open loop such as first open loop section 110 of handheld tool 100 for attaching or coupling to a user's apparel.

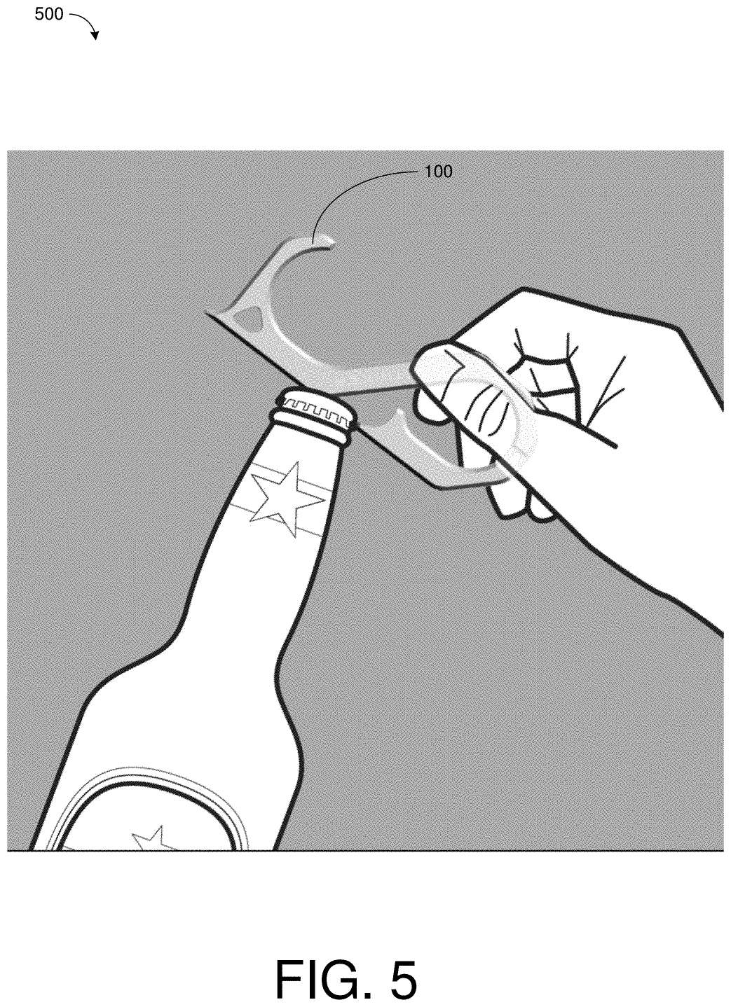

FIG. 5 illustrates an example scenario 500 in accordance with an implementation of the present disclosure. In scenario 500, handheld tool 100 may be used by a user as a bottle opener to open a bottle. In the example shown in FIG. 5, the gap between first pointed tip 118 of first distal end 112 of first open loop section 110 and connection section 130 is configured such that handheld tool 100 functions as a bottle opener with a cap of a bottle removable from the bottle by first pointed tip 118 of first distal end 112 of first open loop section 110 and connection section 130.

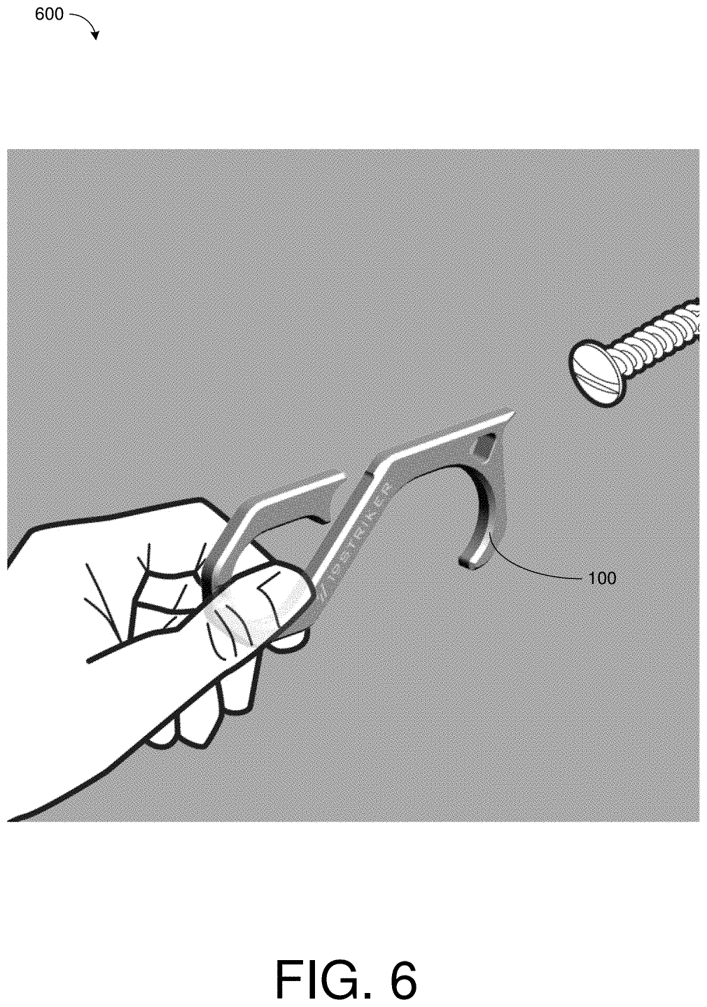

FIG. 6 illustrates an example scenario 600 in accordance with an implementation of the present disclosure. In scenario 600, handheld tool 100 may be used by a user as a screwdriver. In the example shown in FIG. 6, as second pointed tip 128 may be generally shaped like a flat tip of a screwdriver, a user may hold first open loop section 110 of handheld tool 100, functioning as a flathead screwdriver, to operate a screw with second pointed tip 128.

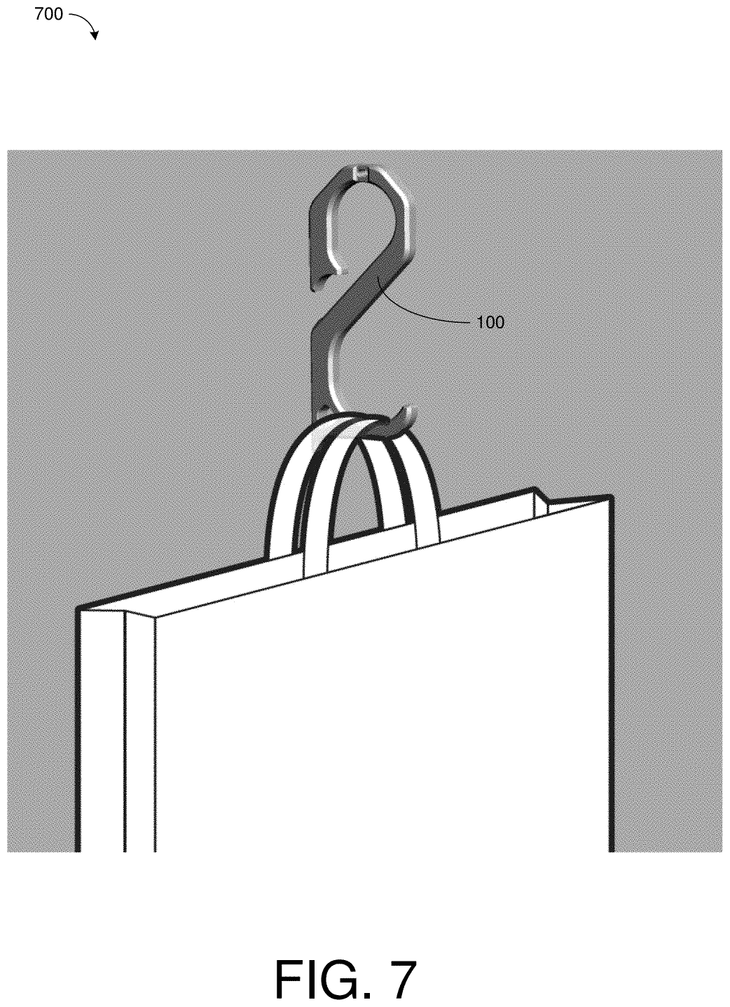

FIG. 7 illustrates an example scenario 700 in accordance with an implementation of the present disclosure. In scenario 700, handheld tool 100 may be used by a user as a coat hanger or bag hanger. In the example shown in FIG. 7, when through hole 116 is used to hang handheld tool 100 onto a fixture (e.g., a nail on a wall), second open loop section 120 may function as a hook of a coat hanger or a bag hanger.

### Example Implementations

In view of the above, the proposed design of a touch-free tool with multiple functions may be implemented in many ways. For illustrative purposes and without limiting the scope of the present disclosure, a few example implementations of the proposed design are described below.

In one aspect, a device may include a handheld tool including a single piece having various sections, namely: a first open loop section, a second open loop section, and a connection section connecting the first open loop section and the second open loop section. The first open loop section may be configured with a first opening toward a first side of the handheld tool. The second open loop section may be configured with a second opening toward a second side of the handheld tool opposite the first side thereof.

In some implementations, the handheld tool may be generally shaped like a letter S, an inverted letter S, a number 2, an inverted number 2, a number 5 or an inverted number 5.

In some implementations, a distal end of the first open loop section may include a curved surface generally facing the second open loop section, a first pointed tip on a first side of the curved surface, and a protruding tip on a second side the curved surface and pointing toward connection section. In some implementations, a gap between the first pointed tip of the distal end of the first open loop section and the connection section may be configured such that the handheld tool functions as a bottle opener with a cap of a bottle removable from the bottle by the first pointed tip of the distal end of the first open loop section and the connection section.

In some implementations, a second pointed tip may protrude outwardly from a midportion of the second open loop section. In some implementations, the second pointed tip may be generally shaped like a flat tip of a screwdriver such that the handheld tool functions as a flathead screwdriver.

In some implementations, a midportion of the first open loop section may be configured with a through hole. In some implementations, when the first open loop section or the through hole is used to hang the handheld tool onto a fixture, the second open loop section may function as a hook of a coat hanger or a bag hanger.

In some implementations, the handheld tool may be made of a metallic material.

In some implementations, the handheld tool may be made of a non-metallic material.

In another aspect, a device may include a handheld tool including a single piece having various sections, namely: a first open loop section, a second open loop section, and a connection section connecting the first open loop section and the second open loop section. The first open loop section may be configured with a first opening toward a first side of the handheld tool. The second open loop section may be configured with a second opening toward a second side of the handheld tool opposite the first side thereof. A first dimension of the first opening, measured from a first distal end of the first open loop section to the connection section, may be less than a second dimension of the second opening, measured from a second distal end of the second open loop section to the connection section.

In some implementations, the handheld tool may be generally shaped like a letter S, an inverted letter S, a number 2, an inverted number 2, a number 5 or an inverted number 5.

In some implementations, the first distal end of the first open loop section may include a curved surface generally facing the second open loop section, a first pointed tip on a first side of the curved surface, and a protruding tip on a second side the curved surface and pointing toward connection section. In some implementations, a gap between the first pointed tip of the first distal end of the first open loop section and the connection section may be configured such that the handheld tool functions as a bottle opener with a cap of a bottle removable from the bottle by the first pointed tip of the first distal end of the first open loop section and the connection section.

In some implementations, a second pointed tip may protrude outwardly from a midportion of the second open loop section. In some implementations, the second pointed tip may be generally shaped like a flat tip of a screwdriver such that the handheld tool functions as a flathead screwdriver.

In some implementations, a midportion of the first open loop section may be configured with a through hole. In some implementations, when the first open loop section or the through hole is used to hang the handheld tool onto a fixture, the second open loop section may function as a hook of a coat hanger or a bag hanger.

In some implementations, the handheld tool may be made of a metallic material.

In some implementations, the handheld tool may be made of a non-metallic material.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A device, comprising:
a handheld tool comprising a single piece having various sections comprising:
a first open loop section with a first opening toward a first side of the handheld tool;
a second open loop section with a second opening toward a second side of the handheld tool opposite the first side thereof; and
a connection section connecting the first open loop section and the second open loop section.

2. The device of claim 1, wherein the handheld tool is generally shaped like a letter S, an inverted letter S, a number 2, an inverted number 2, a number 5 or an inverted number 5.

3. The device of claim 1, wherein a distal end of the first open loop section comprises:
a curved surface generally facing the second open loop section;
a first pointed tip on a first side of the curved surface; and
a protruding tip on a second side the curved surface and pointing toward connection section.

4. The device of claim 3, wherein a gap between the first pointed tip of the distal end of the first open loop section and the connection section is configured such that the handheld tool functions as a bottle opener with a cap of a bottle removable from the bottle by the first pointed tip of the distal end of the first open loop section and the connection section.

5. The device of claim 1, wherein a second pointed tip protrudes outwardly from a midportion of the second open loop section.

6. The device of claim 5, wherein the second pointed tip is generally shaped like a flat tip of a screwdriver such that the handheld tool functions as a flathead screwdriver.

7. The device of claim 1, wherein a midportion of the first open loop section is configured with a through hole.

8. The device of claim 7, wherein, when the first open loop section or the through hole is used to hang the handheld tool onto a fixture, the second open loop section functions as a hook of a coat hanger or a bag hanger.

9. The device of claim 1, wherein the handheld tool is made of a metallic material.

10. The device of claim 1, wherein the handheld tool is made of a non-metallic material.

11. A device, comprising:
a handheld tool comprising a single piece having various sections comprising:
a first open loop section with a first opening toward a first side of the handheld tool;
a second open loop section with a second opening toward a second side of the handheld tool opposite the first side thereof; and
a connection section connecting the first open loop section and the second open loop section,
wherein a first dimension of the first opening, measured from a first distal end of the first open loop section to the connection section, is less than a second dimension of the second opening, measured from a second distal end of the second open loop section to the connection section.

12. The device of claim 11, wherein the handheld tool is generally shaped like a letter S, an inverted letter S, a number 2, an inverted number 2, a number 5 or an inverted number 5.

13. The device of claim 11, wherein the first distal end of the first open loop section comprises:
a curved surface generally facing the second open loop section;
a first pointed tip on a first side of the curved surface; and
a protruding tip on a second side the curved surface and pointing toward connection section.

14. The device of claim 13, wherein a gap between the first pointed tip of the first distal end of the first open loop section and the connection section is configured such that the handheld tool functions as a bottle opener with a cap of a bottle removable from the bottle by the first pointed tip of the first distal end of the first open loop section and the connection section.

15. The device of claim 11, wherein a second pointed tip protrudes outwardly from a midportion of the second open loop section.

16. The device of claim 15, wherein the second pointed tip is generally shaped like a flat tip of a screwdriver such that the handheld tool functions as a flathead screwdriver.

17. The device of claim 11, wherein a midportion of the first open loop section is configured with a through hole.

18. The device of claim 17, wherein, when the first open loop section or the through hole is used to hang the handheld tool onto a fixture, the second open loop section functions as a hook of a coat hanger or a bag hanger.

19. The device of claim 11, wherein the handheld tool is made of a metallic material.

20. The device of claim 11, wherein the handheld tool is made of a non-metallic material.
